(19) United States
(12) Patent Application Publication
(10) Pub. No.: US 2008/0087612 A1
(43) Pub. Date: Apr. 17, 2008

(54) Method for Cleaning a Process Fluid for Offset Printing by Means of Transverse Flow Filtration, as well as a Filtration Device for a Process Fluid

(75) Inventors: Robert Holtwick, Telgte (DE); Christian Walczyk, Munster (DE)

Correspondence Address: RICHARD M. GOLDBERG, 25 EAST SALEM STREET, SUITE 419, HACKENSACK, NJ, 07601, US

(73) Assignee: TECHNOTRANS AG, Sassenberg (DE)

(21) Appl. No.: 11/856,895

(22) Filed: Sep. 18, 2007

(30) Foreign Application Priority Data
Sep. 20, 2006 (DE) 10 2006 044 726.3

(51) Int. Cl. B01D 33/15

(52) U.S. Cl. 210/780; 210/179; 210/359

(57) ABSTRACT

A method for cleaning a process fluid for offset printing by transverse flow filtration, for which the process fluid, which is to be cleaned, flows over the surface (28) of a transverse flow filtration membrane (18), the flow being produced at least partly by a movement of the transverse flow filtration membrane (18) through the process fluid.

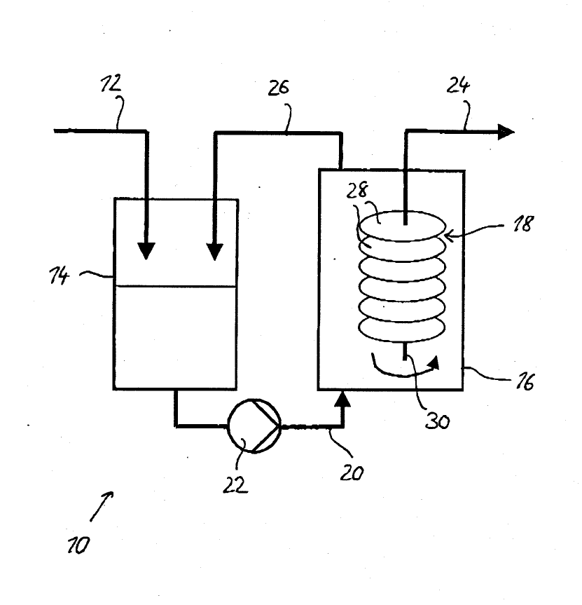

The present invention relates to a method for cleaning a process fluid for offset printing by means of transverse flow filtration, for which the process fluid, which is to be cleaned, flows over the surface of a transverse flow filtration membrane, as well, furthermore, a corresponding filtration device.

For offset printing, the surfaces of the printing plates are wetted uniformly with a fountain solution, which prevents acceptance of printing ink by the non-printing places of the printing plate. Usually, such a fountain solution consists of water and a series of additives, which comprise, in particular, alcohol, as well as anti-corrosive and antimicrobial materials, surface active substances or the like. Because of the volatility of the alcohol, the fountain solution must be kept cool. Usually, the fountain solution circulates between the printing press and a preparation installation, in which it is cleaned and in which losses arising during the operation of the printing press can be compensated for by the addition of fresh fountain solution.

Transverse flow filtration can be used to filter off impurities. For this type of filtration, the process fluid, which is to be cleaned, such as, in particular, the fountain solution, flows over a filter membrane and passes through the latter to the permeate side, from where the cleaned fountain solution can be pumped away as filtrate. The fountain solution must flow at a high flow velocity over the surface of the membrane here. For this purpose, pumps have been used in the past, which pump the fountain solution at a high velocity to the membrane. For this purpose, the pump must have a high output, which, in turn, leads to appreciable warming. This waste heat is introduced into the cycling fountain solution and leads to undesirable evaporation of the volatile components of the fountain solution. It may also happen that the components of a fountain solution are decomposed by the heating as well as possibly also by the pressure produced by the pump. Finally, due to the production of alcohol vapors, the danger may arise that the filtration installation will explode.

It is therefore an object of the present invention to provide a method for cleaning a process fluid using transverse flow filtration, for which excessive heating of the process fluid is avoided and its composition is not affected. In particular, the evaporation of volatile components is to be avoided. The development of an appropriate filtering device for attaining the objectives named above is a further objective.

Pursuant to the invention, these objectives are accomplished by the cleaning method of claim 1 and by the filtration device of claim 7.

For the inventive method, a flow over the surface of the transverse flow filtration membrane is produced in that the membrane itself is moved through the process fluid, for example, the fountain solution. This movement can take place at a high speed, so that the necessary flow velocity at the surface of the membrane, which prevents deposition of solids and leads to an adequate filtration output, is attained. The overflow is not produced by the pump and additional waste heat is not introduced into the cycling process fluid. The process fluid can be kept cool, so that the problems, which are described above and arise when the process fluid is heated, are avoided. The inventive filtration device comprises driving means for the membrane, which may be largely uncoupled thermally from the cycling process fluid and consequently cause no problems with respect to generating heat.

Preferably, the process fluid is a fountain solution.

In a preferred embodiment of the inventive method, the movement comprises a rotation of the transverse flow filtration membrane, the axis of rotation of which is perpendicular to the surface of the membrane.

Preferably, the rotational movement is an oscillating movement about the plane of rotation.

Furthermore, the movement may preferably comprise an oscillating linear movement of the membrane.

In a further preferred embodiment, a portion of the flow is supplementarily produced by a pump, which pumps the process fluid, which is to be cleaned, to the transverse flow filtration membrane. This pump may be operated with a low pumping output, since the flow portion, required for reaching the necessary overflow velocity, can be produced by the movement of the membrane itself. The pump accordingly does not produce any waste heat worth mentioning.

Advantageous developments of the inventive filtration device arise out of the dependent claims 8 to 14.

A preferred example of the invention is explained in greater in the following.

The single FIGURE shows a diagrammatic representation of a preferred embodiment of a filtration device for carrying out the inventive method.

The filtration device 10 serves to clean a fountain solution for offset printing, which is cycled between a printing press, which is not shown, and a peripheral device, which serves for preparing and cleaning fountain solution. The filtration device 10 may be integrated in this peripheral device. The contaminated fountain solution flows over an inlet 12 into the collecting tank 14, in which it is stored to begin with and kept for the filtration process. The filtration takes place in a filtration container 16, in which a transverse flow filtration membrane 18 is disposed. From the collecting tank 14, an inlet 20 leads to a filtration container 16. A pump 22, which pumps the fountain solution, which is to be cleaned, from the collecting tank 14 under pressure into the filtration container 16, is disposed within the inlet 20. The fountain solution, filtered through the transverse flow membrane 18, that is, the filtrate, is passed on the permeate side of the transverse flow filtration membrane through a first outlet 24 and may, once more, be supplied to the printing press. A second outlet 26 leads from the filtration container 16 into the collecting tank 14. Since only a relatively small portion of the fountain solution, pumped by the pump 22 into the filtration container, is cleaned because of the limited capacity of the transverse flow filtration membrane 18 and pumped as filtrate over the first outlet 24, the excess flows over the second outlet 26 back into collecting tank 14.

The method of transverse flow filtration is known as such. The fountain solution flows over the surface of the transverse flow filtration membrane 18 at a high rate, so that any deposition of solids and, with that, blockage of the membrane is prevented. Due to the pressure of the liquid, the fountain solution penetrates through the membrane and, as already described, is pumped away at the permeate side. In the present case, the transverse flow of filtration membrane 18 has a number of parallel, disk-shaped surfaces 28, over which the fountain solution flows in a transverse flow.

For carrying out this method, high overflow velocities are required at the surfaces 28 of the membrane 18. Pursuant to the invention, these high velocities are produced by a movement of the transverse flow filtration membrane 18 through the fountain solution, which is in the filtration container 16. In the example shown here, this movement is a rotation of the transverse flow filtration membrane 18 about an axis of rotation 30, which is perpendicular to the disk-shaped surfaces 28 of the membrane 18. A suitable driving mechanism, which is not shown here for the sake of clarity, may be provided at one end of the axle and drives the membrane 18 in order to rotate it.

In the case shown here, the high flow rate is produced by rotating the surfaces 28 rapidly through the fountain solution. The membrane 18 may also be moved in other ways, for example, in an oscillating linear movement, for which the surfaces 28 are moved back and forth in the fountain solution. A linear driving mechanism would have to be provided for this purpose. An oscillating, rotational movement about the axis of rotation, as well as combinations of rotational and linear movements can also be carried out.

Compared to the prior art, the high flow rate is not produced by the pump 22, which has mainly the function here of pumping the fountain solution, which is to be cleaned, into the filtration container 16. The problem that, due to the high pumping output, which previously was necessary to achieve the high flow rates, heat is introduced into the fountain solution and may lead to an evaporation of the alcohol portion, a decomposition of heat-sensitive fountain solution components, etc., therefore does not arise here. The fountain solution can be filtered in the cooled state in the inventive filtration device 10, without being heated to any extent worth mentioning by this procedure. Optionally, an additional filling device for the fountain solution, such as a cooling coil, may be provided in the collecting tank 14.

The pump 22 may contribute supplementarily to the flow over the transverse flow filtration membrane 18. However, this contribution is to be limited to the extent that heat is not introduced by the pumping output produced, so that the resulting overflow rate is produced mainly by the movement of the transverse flow filtration membrane 18, the contribution by the pump 22 being relatively small.

The present description relates to an inventive filtering device for a fountain solution as well as to a corresponding method. However, the present invention can be used in the same way for cleaning a different process fluid for offset printing.

What is claimed is:

1. A method for cleaning a process fluid for offset printing by means of transverse flow filtration, comprising the steps of:
causing the process fluid, which is to be cleaned, to flow over a surface of a transverse flow filtration membrane, and
moving the transverse flow filtration membrane through the process fluid to produce the flow at least partly by said movement.

2. The method of claim 1, wherein the process fluid is a fountain solution.

3. The method of claim 1, wherein the movement comprises a rotational movement of the transverse flow filtration membrane, the axis of rotation of which is perpendicular to the surface of the membrane.

4. The method of claim 3, wherein the movement of rotation is an oscillating movement of the transverse flow filtration membrane about the axis of rotation.

5. The method of claim 1, wherein the movement comprises an oscillating linear movement of the transverse flow filtration membrane.

6. The method of claim 1, further comprising the step of supplementing the flow by a pump, which pumps the process fluid to the transverse flow of filtration membrane.

7. A filtration device for a process fluid for offset printing, comprising:
a transverse flow filtration membrane having a surface, and
an arrangement for producing a flow over the surface of the transverse flow filtration membrane, the arrangement including at least one driving mechanism for moving the transverse flow filtration membrane through the process fluid.

8. The filtration device of claim 7, wherein the filtration device is provided for filtering a fountain solution.

9. The filtration device of claim 7, wherein the arrangement includes a rotational driving mechanism, the axis of rotation of which is perpendicular to the surface of the membrane.

10. The filtration device of claim 7, wherein the arrangement includes, a linear driving mechanism.

11. The filtration device of claim 7, wherein the driving mechanism is provided for driving the membrane to perform an oscillating movement.

12. The filtration device of claim 7, wherein the arrangement further includes a pump, which pumps the process fluid, which is to be cleaned, to the transverse flow filtration membrane.

13. The filtration device of claim 7, further comprising:
a collecting tank for storing process fluid that has not been cleaned,
a filtration container, in which the transverse filtration membrane is disposed,
an inlet from the collecting tank to the filtration container in which a pump is disposed,
a first outlet, connected at a permeates side of the filtration container for discharging the filtrate and
a second outlet for returning process fluid, which has not been cleaned, to the collecting tank.

14. The filtering device of claim 13, wherein the collecting tank comprises a cooling device for the stored process fluid.
